(19) United States
(12) Patent Application Publication
(10) Pub. No.: US 2014/0196421 A1
(43) Pub. Date: Jul. 17, 2014

(54) UREA FILTER MATERIAL

(71) Applicants: Stefan Jauss, Donzdorf (DE); Sven Siegle, Winnenden (DE); Anette Arnold, Schriesheim (DE); Thomas Kuehlwein, Laumersheim (DE); Holger Leubner, Hemsbach (DE)

(72) Inventors: Stefan Jauss, Donzdorf (DE); Sven Siegle, Winnenden (DE); Anette Arnold, Schriesheim (DE); Thomas Kuehlwein, Laumersheim (DE); Holger Leubner, Hemsbach (DE)

(73) Assignees: CARL FREUDENBERG KG, Weinheim (DE); MAHLE INTERNATIONAL GMBH, Stuttgart (DE)

(21) Appl. No.: 13/983,332

(22) PCT Filed: Feb. 2, 2012
(86) PCT No.: PCT/EP2012/051772

§ 371 Date: Feb. 17, 2014

(30) Foreign Application Priority Data
Feb. 3, 2011 (DE) 10 2011 003 585.0

(51) Int. Cl. B01D 39/16; B01D 46/14

(52) U.S. Cl. CPC B01D 39/1623; B01D 46/14
USPC 55/497; 55/528

(57) ABSTRACT

A urea filter material may have a base layer, a cover layer and a filter layer arranged between the base layer and the cover layer, wherein all of the layers are formed from polypropylene non-woven fabric.

### CROSS-REFERENCE TO RELATED APPLICATIONS

This application claims priority to German Patent Application 10 2011 003 585.0 filed Feb. 3, 2011, and International Patent Application PCT/EP2012/051772 filed on Feb. 2, 2012, both of which are hereby incorporated by reference in their entirety.

### TECHNICAL FIELD

The present invention relates to a urea filter material for a urea filter as well as a urea filter element comprising such a urea filter material.

### BACKGROUND

Urea is used in modern motor vehicles for reducing nitric oxides in the exhaust gas of the internal combustion engine, where the so-called SCR method (selective catalytic reduction) is increasingly being used here. In the SCR method urea is injected into the hot exhaust gas stream and decomposes to ammonia which reduces the nitric oxides in a downstream catalyst. Urea injected into the exhaust gas in such a manner therefore overall promotes the emission behaviour of the motor vehicle. In general, the urea in motor vehicles is filtered before use here, that is before injection into the exhaust gas stream, for which urea filters are used. A disadvantage of known urea filters is that these are only durable to a certain extent on account of the aggressive environment produced by the urea.

### SUMMARY

The present invention is concerned with the problem of providing an improved embodiment for a urea filter material which in particular is characterised by an increased service life.

This problem is solved according to the invention by the subject matters of the independent claims. Advantageous embodiments are the subject matter of the dependent claims.

The invention is based on the general idea of configuring a urea filter material for a urea filter as three-layered, that is having three layers, i.e. a base layer, a cover layer and a filter layer lying therebetween, where all the layers of the urea filter material are formed from polypropylene, in particular as polypropylene non-woven fabric. Polypropylene is a partially crystalline thermoplastic and belongs to the group of polyolefins. At the same time, polypropylene is resistant at room temperature to almost all common solvents and chemicals, with the result that the urea filter material made exclusively from polypropylene non-woven fabric has the desired long service life. In addition, as a result of the three-layered structure of the urea filter material according to the invention, a particularly resistant filter material can be obtained which, in addition to chemical loads, can also withstand high mechanical loads caused by the flow through the urea filter material during operation. At the same time, the urea filter material according to the invention also has a high resistance to a so-called freeze swelling. Freeze swelling means the anomaly of water to increase its volume on freezing. UREA consists of about 70% water. A certain amount of urea solution always remains in a urea filter, and this expands upon freezing as a result of its water fraction. A suitable urea filter material should permanently withstand this swelling.

In an advantageous further development of the solution according to the invention, the base layer and the filter layer are welded together, in particular welded together by means of ultrasound, whereas the filter layer and the cover layer are stamped together, in particular joined together by means of thermal rolling. By means of the ultrasound welding a simple and at the same time permanent connection of the filter layer and the base layer can be achieved, where the two layers are preferably only welded together at specific contact points. The base layer, also called for example support non-woven fabric, can then be stamped with the filter layer by means of the thermally heated rollers. The afore-mentioned methods already confirm that the filter material according to the invention can be produced efficiently in terms of production technology and therefore cost-effectively. Naturally, instead of the welding or stamping, other suitable joining methods such as, for example, needling, felting, fusion or adhesive bonding are also feasible, where the individual joining methods should always be selected depending on the structure of the individual layers of the urea filter material.

The present invention furthermore relates to a urea filter element comprising a urea filter material, where the urea filter element is configured as an annular filter element and the urea filter material has the shaped of a pleated star. An upper and a lower end disk of such an annular filter element are in this case preferably also formed of polypropylene like the urea filter material and as a result are highly resistant to chemicals and solutions. The upper and the lower end disk can be adhesively bonded, fused or welded to the front sides of the pleated star made of the urea filter material so that exclusively one passage in the radial direction through the urea filter element is possible.

Further important features and advantages of the invention are obtained from the subclaims, from the drawings and from the relevant description of the figures with reference to the drawings.

It is understood that the features mentioned previously and to be explained hereinafter can be used not only in the respectively given combination but also in other combinations or alone without departing from the framework of the present invention.

Preferred exemplary embodiments of the invention are shown in the drawings and will be explained in detail in the following description, where the same reference numbers relate to the same or similar or functionally the same components.

### BRIEF DESCRIPTION OF THE DRAWINGS

In the figures, in each case schematically

FIG. 1 shows a sectional view of a urea filter material according to the invention,

FIG. 2 shows a possible embodiment of a urea filter element comprising the urea filter material according to the invention.

### DETAILED DESCRIPTION

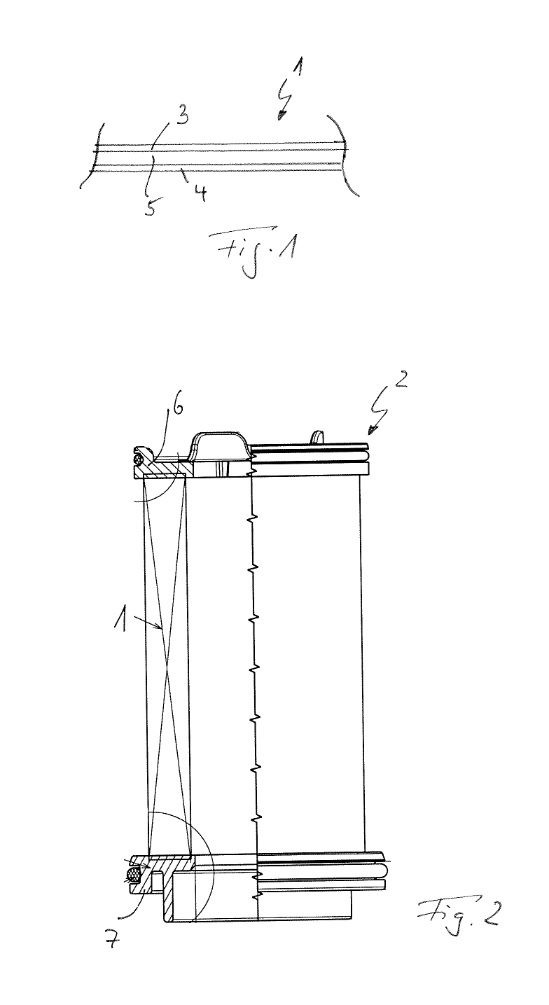

According to FIG. 1, a urea filter material 1 for a urea filter element 2 shown according to FIG. 2 comprises three layers, i.e. a base layer 3, a cover layer 4 and a filter layer 5 lying therebetween. All these said layers 3, 4, 5 are formed according to the invention of polypropylene, in particular of a polypropylene non-woven fabric. The base layer 3 and the filter layer 5 are welded together, in particular welded together by means of ultrasound methods, where, for example, merely spotwise fixing of the base layer 3 to the filter layer 5 is possible. In contrast to this, the filter layer 5 and the cover layer 4 are stamped together, in particular joined together by means of heated rollers. Naturally other joining methods such as, for example, adhesive bonding, needling, felting etc. are feasible. However, all three layers 3 to 5 can be joined simultaneously (ultrasound or thermally). The thicknesses of the individual layers 3 to 5 shown according to FIG. 1 are to be understood merely as pure examples so that it is naturally possible that the filter layer 5 is thicker or thinner than the base layer 3. Furthermore, the individual layers 3, 4 and 5 can have different strengths and/or different filter properties. The individual fibres of the layers 3 to 5 forming the non-woven fabric can have different fibre thicknesses and/or different fibre lengths. The individual layers can be fabricated as so-called spunbond nonwovens and have a high resistance to chemicals and solutions, with the result that they are particularly suitable for the aggressive environment prevailing in the urea filter. Naturally, different methods of manufacture such as, for example, the so-called “melt-blown” method are also feasible for the individual layers 3 to 5. In the so-called melt-blown method, molten plastic is acted upon with compressed air and the actual fibres are thus obtained.

The base layer 3 consists of a more stable polypropylene non-woven fabric which primarily ensures the supporting function for the filter layer 5. Whereas the filter layer 5 consists of a more voluminous polypropylene non-woven fabric in order to guarantee the desired filter effect by means of suitable pore size. The cover layer 4 should in turn ensure that the soft filter layer 5 is not destroyed by mechanical friction. It therefore consists of a comparatively thin and smooth polypropylene non-woven fabric.

If FIG. 2 is considered, the urea filter element 2 according to the invention can be seen, which in the present form is configured as an annular filter element. In this case, the urea filter material is folded as a pleated star and has flow therethrough in the radial direction. A first and a second end disk 6, 7 terminate the pleated star in the axial direction, where the two end disks 6, 7 are also formed from polypropylene. The front sides of the pleated star are tightly connected to the respective end disks 6, 7, in particular adhesively bonded or fused. The end disks 6, 7 are fitted with seals or openings according to the requirement for the urea filter element 2.

In general, the urea filter material 1 according to the invention has an exceptionally good media resistance, in particular with respect to mechanical loads during freezing during which the volume increases.

1. A urea filter material for a urea filter, comprising: a base layer, a cover layer and a filter layer arranged between the base layer and the cover layer, wherein all of the layers are formed from polypropylene non-woven fabric.

2. The urea filter material according to claim 1, wherein at least the base layer and the filter layer are welded together.

3. The urea filter material according to claim 1, wherein at least the filter layer and the cover layer are stamped together.

4. The urea filter material according to claim 1, wherein the layers differ from each other in at least one of thicknesses, strengths and filter properties.

5. The urea filter material according to claim 1, wherein the layers include fibres of varying thickness and length.

6. A urea filter element comprising: a urea filter material having a base layer, a cover layer and a filter layer arranged between the base layer and the cover layer, wherein all of the layers are formed from polypropylene non-woven fabric.

7. The urea filter element according to claim 6, wherein the urea filter element is configured as an annular filter element and the urea filter material forms a pleated star, and further comprising a first and a second end disk arranged at opposite ends of the filter material, wherein the end disks are made of polypropylene.

8. The urea filter element according to claim 6, wherein at least the base layer and the filter layer are welded together.

9. The urea filter element according to claim 8, wherein at least the base layer and the filter layer are welded via ultrasonic welding.

10. The urea filter element according to claim 6, wherein at least the filter layer and the cover layer are stamped together.

11. The urea filter element according to claim 10, wherein at least the filter layer and the cover layer are stamped together via thermal rolling.

12. The urea filter element according to claim 6, wherein the layers differ from each other in at least one of thicknesses, strengths and filter properties.

13. The urea filter element according to claim 6, wherein the layers include fibres of varying thickness and length.

14. The urea filter material according to claim 2, wherein at least the base layer and the filter layer are welded together via ultrasonic welding.

15. The urea filter material according to claim 2, wherein the layers differ from each other in at least one of thicknesses, strengths and filter properties.

16. The urea filter element according to claim 2, wherein the layers include fibres of varying thickness and length.

17. The urea filter material according to claim 3, wherein at least the filter layer and the cover layer are stamped together via thermal rolling.

18. The urea filter material according to claim 3, wherein the layers differ from each other in at least one of thicknesses, strengths and filter properties.

19. The urea filter element according to claim 3, wherein the layers include fibres of varying thickness and length.

20. The urea filter element according to claim 4, wherein the layers include fibres of varying thickness and length.
